(19) United States
(12) Patent Application Publication
(10) Pub. No.: US 2011/0316194 A1
(43) Pub. Date: Dec. 29, 2011

(54) Method And Apparatus For Dry Casting Concrete Blocks Having A Decorative Face

(75) Inventor: Jeremy L. Manthei, Charlevoix, MI (US)

(73) Assignee: Rosetta Hardscapes, LLC, Charlevix, MI (US)

(21) Appl. No.: 13/046,029

(22) Filed: Mar. 11, 2011

Related U.S. Application Data
(60) Provisional application No. 61/357,963, filed on Jun. 23, 2010.

(51) Int. Cl. B28B 7/30

(52) U.S. Cl. 264/313; 425/436 R

(57) ABSTRACT

A method and apparatus for dry casting concrete wall blocks having a decorative face. The blocks are cast in a mold including a form, a flexible insert and a steel pallet. Magnets hold the insert on the pallet while permitting the insert to slide on the pallet into alignment with the form when the form and pallet are moved together. The insert creates a decorative face on one or more simultaneously cast blocks. After the blocks are cast, the uncured blocks and the insert are moved together from the form and transferred to a curing area. After the blocks cure, they are separated from the insert. Preferably, additional concrete mix is provided adjacent the insert prior to compacting to avoid voids in the block face. Optionally, the shoe which compacts the concrete mix may be shaped to impart a lip adjacent a back edge of the block.

### CROSS-REFERENCE TO RELATED APPLICATIONS

Applicants claim priority to U.S. Provisional Patent Application Ser. No. 61/357,963 filed Jun. 23, 2010.

### STATEMENT REGARDING FEDERALLY SPONSORED RESEARCH OR DEVELOPMENT

Not Applicable.

### TECHNICAL FIELD

The invention relates to a method and apparatus for dry casting concrete blocks having decorative faces.

### BACKGROUND OF THE INVENTION

Two methods are commonly used for casting concrete blocks: wet casting and dry casting. In a wet casting process, liquid concrete is poured into a block mold cavity and remains in the cavity until the concrete has cured sufficiently to permit removal without damage to the cast block. During the cure time, the mold cannot be used for casting additional blocks. When one or more surfaces of the block are to be decorative, the bottom of the cavity may be lined with, for example, a urethane insert shaped to impart a desired texture or decoration to the cast block. This process may be used, for example, to form concrete blocks with a face which simulates natural stone with irregular fissures.

In a typical dry casting process, a form having an open top and an open bottom is places on a rigid support surface such as a steel pallet to define one or more mold cavities. The mold cavities are then filled with a relatively dry cement mixture, which is granular and not as fluid as in the cement used in wet casting. The dry cast cement mixture is then pressed into the mold cavity with sufficient pressure to form an uncured block. The uncured block has sufficient rigidity to hold its shape when separated from the form. After the block is separated from the form, it is transferred to a curing station and the form can be immediately reused for casting additional blocks. The dry casting process is commonly used for casting concrete building foundation and wall blocks. These blocks frequently have vertical passages which reduce the weight of the blocks and are not decorative. Dry casting has in the past only been suitable for producing plain blocks and blocks having a face with limited shallow decorations. Blocks with vertical passages and some texture on the face have been made using dry casting machines by casting two blocks as a single unit and, after the blocks have cured, breaking the blocks apart into two separate blocks. Deeper patterns have not been achievable due to problems with the relatively soft uncured block breaking when separating the block from the mold which forms the decorative surface.

In operating prior art dry casting block machines, the forms have been provided with either straight sides or with a slight relief angle so that the form can be separated from the uncured blocks without breaking the blocks. This has prevented use of the forms for imparting projections and notches on the top or bottom of the blocks which can be used to align blocks stacked to form a wall.

### BRIEF SUMMARY OF THE INVENTION

The invention is directed to a cement block dry casting method and apparatus for casting one or more blocks. The blocks have a decorative face which may have a deep texture on the block face. For example, the cast blocks may simulate natural stone blocks with relative deep simulated cracks or fissures and irregularities on the block face. Optionally, the blocks also may be formed with either a groove or a ridge in either the top or the bottom of the block. By placing a ridge along the lower back edge of the block, the blocks may be stacked into a stable sloping wall.

The blocks are cast in a form which has a mold cavity using commercially available dry cast block machines, such as those manufactured by Besser Company of Alpena, Mich. A resilient insert forms one vertical side of the cavity. The insert is shaped to form a desired textured face on at least one side of the cast block. The block is cast by filling the cavity with dry cast concrete mix, compacting the dry cast concrete mix in the cavity by pressing down on the top of the mix, removing the block and the insert together from the form, and keeping the block and the insert together until after the block has cured. Preferably, the insert separates the mold into an even number of cavities for forming the faces on an even number of simultaneously cast blocks. In this case, all of the blocks and the insert are removed together from the form and transferred together to the curing area.

In a typical dry cast block machine, the form is vibrated as the cavities are filled with dry cast concrete mix. After the cavities are filled, the mix will extend above the top of the form. A doctor is then passed over the top of the form to scrape away the excess mix. A shoe on a head assembly having the shape of the open mold cavity tops is then moved down towards a pallet on which the form sits and into the tops of the cavities for compacting the mix to form the uncured blocks. While maintaining the position of the shoe after the blocks are formed, the form is separated from the blocks and pallet, leaving the uncured blocks on the pallet. The pallet may be moved to a different location, or the blocks and the inserts may be pushed onto a conveyor or another pallet for transfer to a curing area.

According to one feature of the invention, the doctor may be shaped to leave a ridge or windrow of dry cast concrete mix above the top of the form next to the location of the insert. A separate windrow is formed adjacent the insert above each mold cavity. The windrows are sized to assure that there is sufficient mix for forming a complete face on each block.

According to another feature of the invention, since the face of the block is cast on a side of the cavity, the shoe and the pallet form the top and bottom of the block. For a standard block, the top and bottom may be interchangeable. The shoe may be shaped to form a rear lip extending above the back edge of the block. When the blocks are inverted and stacked in rows to form a wall, the rear lip may position the upper blocks slightly behind the adjacent lower blocks for providing a stable, sloping wall.

According to another feature of the invention, the insert which creates the face of the cast blocks is positioned on the steel pallet before the pallet and the form are brought together either by raising the pallet or by lowering the form, or by moving both. Preferably, the insert is made from a resilient rubber like material, such as a polyurethane material. Magnets may be embedded in the bottom of the insert to help maintain the position of the insert on the steel pallet, while permitting the insert to slide on the pallet for alignment with the form. Further, a tough, wear resistant layer may be secured to the bottom of the insert to reduce wear when the cast blocks and the insert are pushed from the pallet. When viewed from the top or bottom, the insert is generally rectangular, with two opposing ends which will abut the form and two opposing sides which will open into the mold cavities for forming the faces of two blocks. The ends of the blocks are slightly angled towards each other and the sides of the blocks are slightly angled towards each other. When the insert and the form are brought together, the ends are engaged by complementary angled grooves in the form so that the insert will move, as necessary, on the pallet to align with the form.

Various objects and advantages of the invention will become apparent from the following detailed description of the invention and the accompanying drawings.

### BRIEF DESCRIPTION OF THE DRAWINGS

FIG. 1 is a perspective view of an exemplary block manufactured in accordance with the invention;

FIG. 2 is a top plan view of the block of FIG. 1;

FIG. 3 is a perspective view of a two cavity mold positioned on a pallet for simultaneously dry casting two concrete wall blocks having textured or decorative faces;

FIG. 4 is a perspective view as seen from an upper corner of a resilient mold insert for separating the cavities in which the two blocks are cast and for simultaneously forming the decorative faces on each of the cast blocks;

FIG. 5 is an end view of the insert of FIG. 4;

FIG. 6 is a perspective view showing the insert of FIG. 3 positioned on a steel pallet prior to positioning the mold and pallet together;

FIG. 7 is a fragmentary view cross sectional end view showing the resilient insert on the pallet being moved into and aligning with the mold to separate the two block cavities;

FIG. 8 is a cross sections side view showing the resilient insert on the pallet being moved into and aligning with the mold to separate the two block cavities;

FIG. 9 is a cross sectional view of the mold and the pallet of FIG. 3 and showing a doctor for scraping excess dry cast concrete mix from the top of the mold;

FIG. 10 is cross sectional view through the mold showing the dry concrete mix being compressed into a block;

FIG. 11 is cross sectional view showing the block being ejected from the mold;

FIG. 12 is a top plan view showing two blocks and an insert on a pallet after the blocks have been cast and separated from the form in which they were cast;

FIG. 13 is perspective view of a modified block made in accordance with the invention, with the block shown inverted;

FIG. 14 is cross sectional view showing the block of FIG. 12 being formed in a mold;

FIG. 15 is a cross sectional plan view showing a modified embodiment of a mold for simultaneously casting 6 blocks with two opposing textured faces on each block; and

FIG. 16 is a cross sectional plan view showing a modified embodiment of a mold for simultaneously casting two corner blocks with textured faces on two adjacent sides of each block.

### DETAILED DESCRIPTION OF THE INVENTION

In a conventional dry casting block machine, a form for shaping sides of the block is positioned on a steel pallet or other rigid support surface. The form has an open top and an open bottom which is closed by the support surface and may have a single mold cavity for casting a single block, or may have a plurality of mold cavities for simultaneously casting a number of concrete blocks. Each cavity is then filled with a dry casting concrete mixture. Typically, the form is vibrated to distribute the concrete mixture in the cavities as the form is filled. A head assembly carrying a shoe is mounted on the machine to be positioned above each cavity. The shoe has the same shape and size as the mold cavities so that it can be lowered into the upper openings into the cavities. A shoe is then lowered into the top of each form cavity and a high pressure is applied to each shoe for simultaneously pressing and compacting the dry cast concrete in each cavity. The applied pressure may be, for example, in the range of 2,000 to 10,000 pounds, or more. It should be appreciated that higher pressures may be required with larger blocks are formed. After the blocks are formed, the pressure on each shoe is reduced to a level for holding the blocks on the pallet while the form is lifted from the blocks, and the shoes are then retracted. The blocks are then transferred to a curing area.

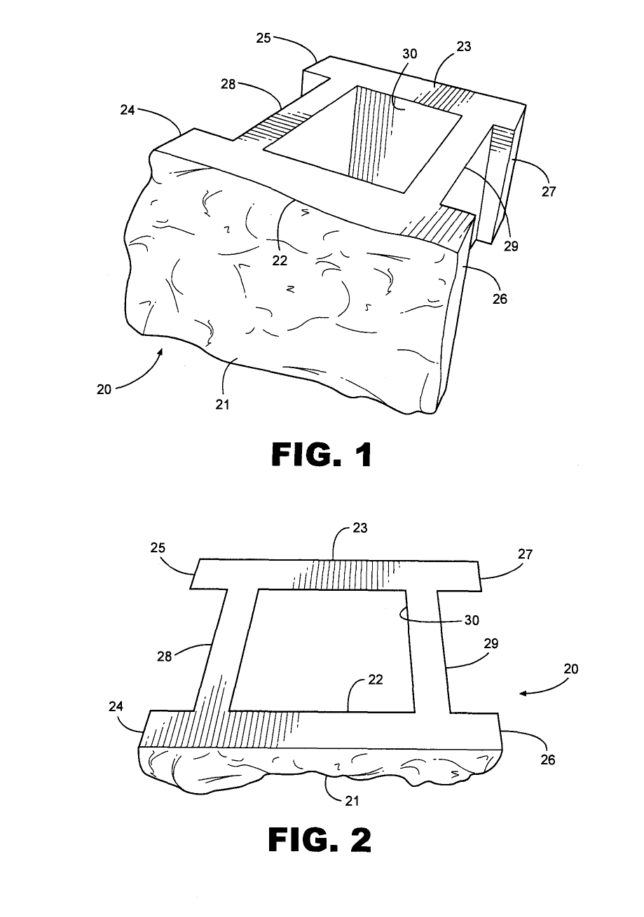

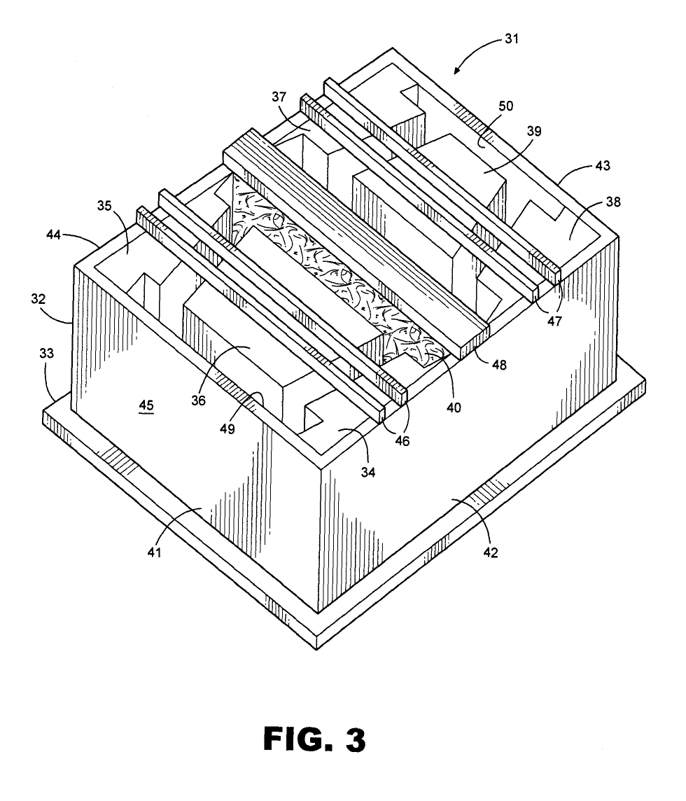

Referring first to FIGS. 1 and 2 of the drawings, an exemplary dry cast concrete block 20 made in accordance with the invention is illustrated. The block 20 has a textured face 21 which forms the exposed portion of a front side 22 when the block 20 is installed in a wall (not shown). As used herein, the term “textured” is used to describe a block face which simulates natural stone, or has a pattern or has a design other than a plain flat face. The textured face may have relatively deep grooves and recesses such as simulated fissures and irregularities which might occur in natural stone. A back side 23 of the block 20 is spaced from the front side 22. The back side 23 is shorter than the front side 22. Left side portions 24 and 25 of the front side 22 and the back side 23, respectively, are aligned, and right side portions 26 and 27 of the front side 22 and the back side 23, respectively. Thus, the outer edges of the block 20 when the block is viewed in plan generally form a trapezoid. This shape allows blocks 20 to be positioned in a straight row with the faces 21 of adjacent blocks abutting, or adjacent blocks may be angled relative to each other with the block faces still abutting for forming curved or angled wall sections. The front and back block sides 22 and 23 are connected together by two webs 28 and 29. The web 28 is spaced inwardly from the left sides 24 and 25 and the web 29 is spaced inwardly from the right sides 26 and 27. The block has a vertical central passage 30 between the front side 22, the back side 23, and the webs 28 and 29.

Blocks similar to the block 20, but without the textured face 21, have been made in the past using dry cast concrete block forming machines. The only way the blocks with textured faces were made with dry cast concrete block forming machines was to cast two blocks as a single unit with the portions that become the faces of the blocks formed together. The unit was fractured in the middle to separate the two blocks. The faces of the blocks would be formed by the irregular fracture.

FIG. 3 illustrates an exemplary mold 31 for simultaneously casting two wall blocks 20 in accordance with the invention. The mold 31 generally consists of a steel form 32, a steel pallet 33 on which the form 32 sits, a plurality of cores 34-39 secured to the form 32 and a flexible insert 40. It should be appreciated that the cores 34-39 are specific for producing blocks having the configuration of the block 20. The number of cores, the shapes of the cores and locations of the cores will vary with the design of the block being produces. The cores reduce the amount of concrete in the blocks to reduce the manufacturing cost and also reduce the weight of the blocks to reduce transportation costs. For a rectangular block having a decorative face and straight sides, no cores may be necessary. The cores may be made from any strong, abrasion resistant material, such as steel. Except as noted below, the insert 40 is made from a durable, flexible material, such as polyurethane.

The form 32 is formed from a strong material, preferably steel. The form 32 has 4 sides 41-44 which are the same height as the height of the block 20. The sides 41-44 are secured together to form an open top and open bottom rectangular box 45. Steel stringers are secured to the top of the box 45 as necessary for securing the cores to the box 45. In the illustrated form 31, two stringers 46 are secured to the tops of the opposing sides 42 and 44 for mounting the cores 34-36, and two stringers 47 are secured to the tops of the opposing sides 42 and 44 for mounting the cores 37-39. The stringers 46 and 47 all extend parallel to the opposing box sides 41 and 43. A plate 48 is mounted on the top of the box 45 to extend between the sides 42 and 44 above the insert 40. The plate 48 also is parallel to the opposing box sides 41 and 43. As will be discussed below, by having the stringers 46 and 47 and the plate 48 parallel, a doctor or squeegee (not shown) can be wiped across the top of the box for leveling the dry concrete mix.

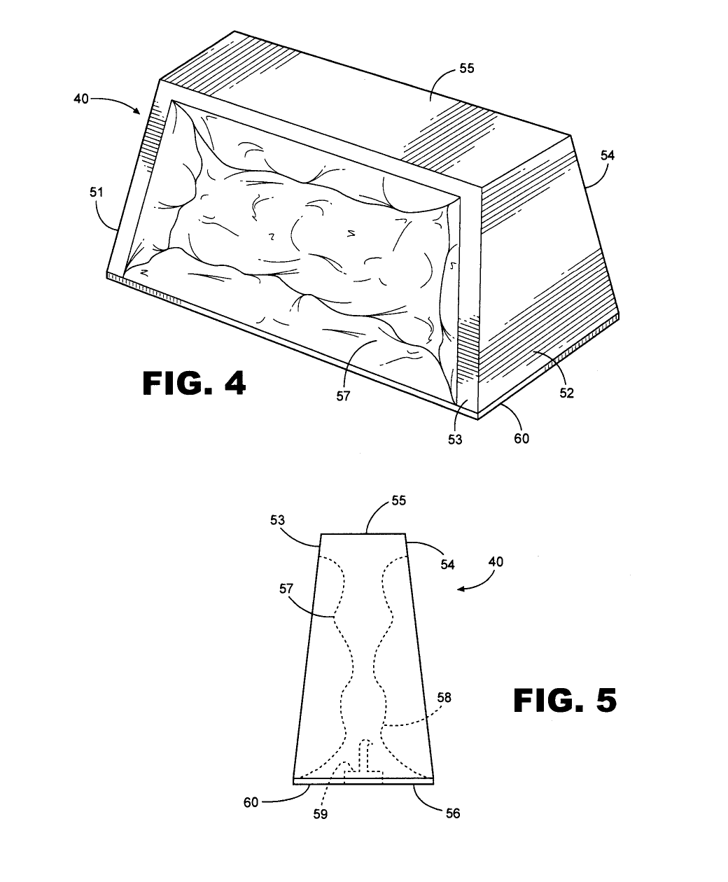

The illustrated mold 31 has two cavities 49 and 50 for simultaneously casting two of the blocks 20. The flexible insert 40 separates the two cavities 49 and 50. Details of the insert 40 are shown in FIGS. 4 and 5. The exterior of the insert 40 is generally in the shape of a truncated pyramid and appears trapezoidal when viewed from any side. Two opposing sides 51 and 52 of the insert 40 have a slight angle relative to each other, and two opposing sides 53 and 54 are shown as having a slightly greater angle relative to each other. The insert 40 has a flat top 55 and a flat bottom 56. The wider bottom 56 provides a stable base for the insert 40.

The insert side 53 has a recessed area 57 which is shaped to cast a textured face 21 of a first block 20 and the insert side 54 has a recessed area 58 which is shaped to cast a textured face 21 of a second block 20. The recessed areas 57 and 58 may be identical for casting blocks 20 having identical faces 21, or may be of different for casting blocks with different textures on their faces 21. Although not required, it is desirable to have the volumes of the two recessed areas 57 and 58 substantially the same.

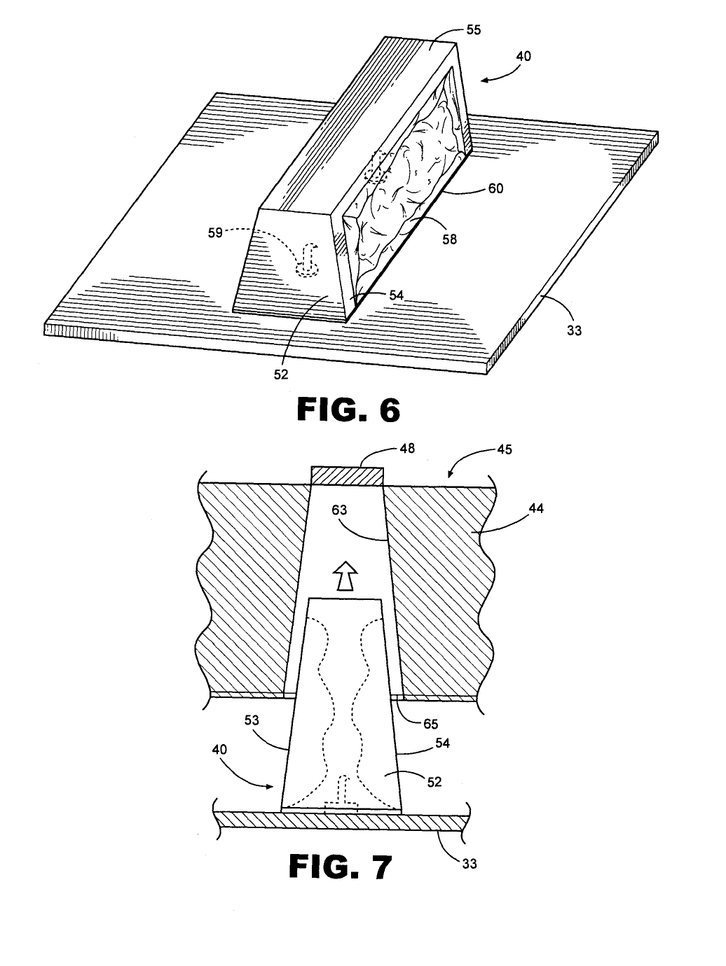

Prior to positioning the insert 40 in the form 32, the insert 40 is placed on the steel pallet 33, as shown in FIG. 6. Preferably, two or more magnets 59 are embedded in the insert 40 adjacent the bottom 56. The magnets 59 are attracted to the steel pallet 33 to reduce unwanted movement of the insert 40 relative to the pallet 33 as the pallet 33 and insert 40 are moved towards the form 32. However, the insert 40 should be able to slide relative to the pallet 33 to allow the insert to align with the form 32 and also to allow the cast blocks 20 and the insert 40 to be pushed together off of the pallet 33 after the blocks 20 are formed. The dry cast concrete mix is granular and includes sand. It will be appreciated that some of the concrete mix can accumulate on the steel pallet 33, which can be abrasive on the insert 40 when it is pushed on the pallet 33. Preferably, an abrasion resistant wear plate 60 is attached to the bottom 56 of the insert 40. The wear plate 60 is made from a tough, abrasion resistant material, such as nylon. The wear plate 60 does not need to be flexible.

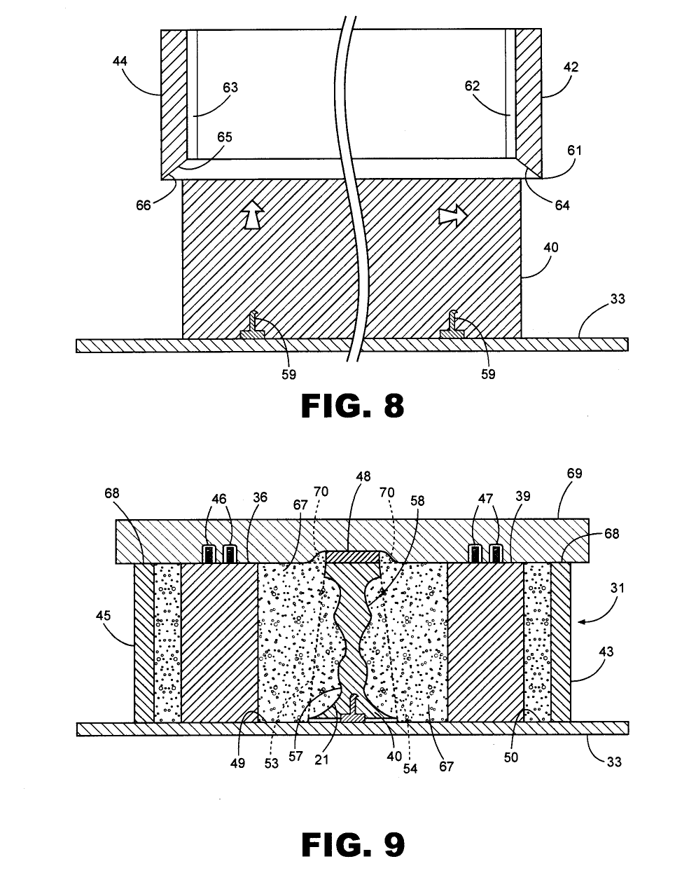

In one typical design for a dry cast block machine, the form 32 is rigidly mounted. However, there is sufficient movement of the form 32 to allow it to be vibrated to help the dry cast cement mix uniformly fill the mold cavities. As shown in FIGS. 7 and 8, the steel pallet 33 is raised up against a bottom edge 61 of the form 32 to close the bottom of the cavities 49 and 50. As the insert 40 is moved into the form 32, the insert 40 can slide on the pallet 33, as necessary, for alignment with the form 32. The magnets keep the insert 32 upright on the pallet 33 as the insert 40 is moved into alignment. Alignment of the insert 40 is accomplished by the angles sides 51-54 on the insert 40 and corresponding angled recess 62 on the form side 42 and a similarly angled recess 63 on the form side 44. As shown in FIGS. 8 and 9, a lower portion 64 of the recess 62 may have a greater slope and a lower portion 65 of the recess 63 may have a greater slope to provide a larger area for initially aligning the insert 40 with the form 32. In FIG. 8, an upwardly directed arrow shows the direction that the pallet 33 and insert 40 are moving and an arrow directed to the right shows the direction that the insert 40 is will move due to a point of contact 65 between the insert 40 and the surface 65

FIG. 9 is a cross sectional view through the mold 31 with the cavities 49 and 50 filled with dry cast concrete mix 67, prior to compacting. As stated above, the mold 31 is vibrated as the cavities 49 and 50 are filled to provide a uniform distribution of the mix 67 in the cavities. After the cavities are filled, excess mix 67 will extend above the mold cavities. A doctor or scraper 68 is then moved across a top 68 of the form 32 to level the concrete mix 67 with the form top 68. The doctor 69 is notched for the stringers 46 and 47 and for the plate 48. According to another feature of the invention, the doctor 69 may be provided with a notched area 70 on each side of the plate 48 for leaving a windrow or ridge of concrete mix 67 above the mold cavities 49 and 50 adjacent the insert 40. This provides additional concrete mix 67 which helps assure that the concrete within the insert recessed areas 57 and 58 is sufficiently compacted to form complete faces on each cast block.

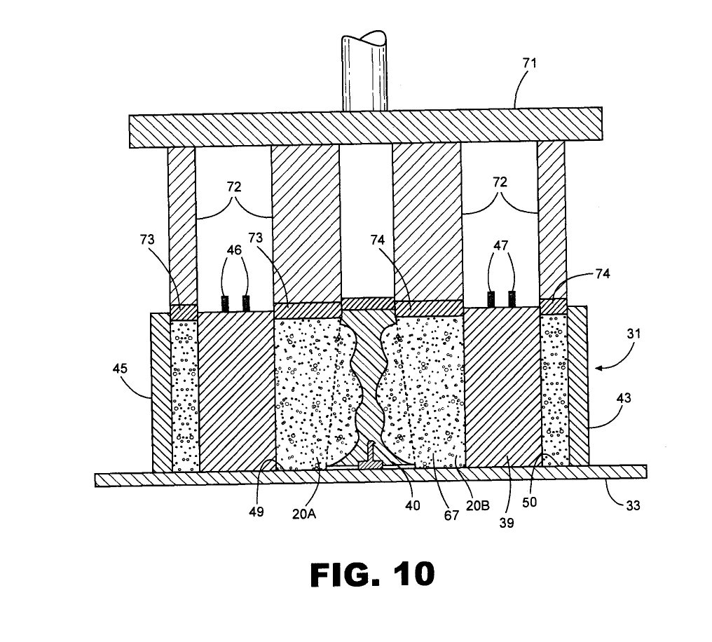

After the mold cavities 49 and 50 are filled with the concrete mix 67, the concrete mix 67 is compressed to form a block. The compressed concrete mix 67 has sufficient strength to permit the block to retain its shape when it is ejected from the mold 31. FIG. 10 shows a head assembly 71 for compressing the concrete mix 67. The head assembly 71 is mounted on the block forming machine for up and down reciprocal movement. The exemplary head assembly 71 includes a rigid structure 72 which is moved by a reciprocating mechanism (not shown) which is typically hydraulically operated. The reciprocating mechanism is a standard component of commercial dry mix concrete block casting machines. A separate shoe 73 and 74 is mounted on the head assembly for each mold cavity. The illustrated two block mold 31 has two cavities 49 and 50 in which blocks 20a and 20b are cast.

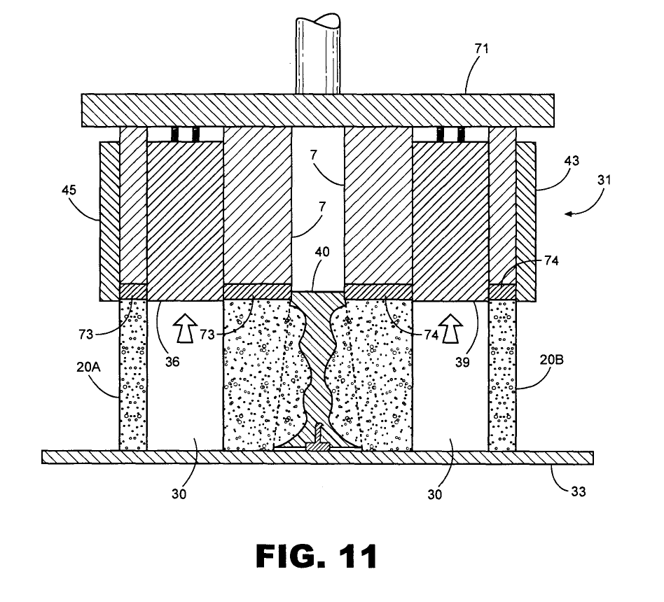

The shoe 73 has a cross section throughout its height corresponding to the size and shape of the top of the cavity 49 for compacting cement mix in the cavity 49, and the shoe 74 has a cross section throughout its height corresponding to the size and shape of the top of the cavity 50 for compacting cement mix in the cavity 50. The shoes 73 and 74 have the same height which is at least as high as the height of the form 32. In operation, the head assembly 71 is lowered and the shoes 73 and 74 press against the concrete mix in the cavities 49 and 50 to compact the concrete mix, forming the blocks 20a and 20b. After the concrete mix is compacted, the head assembly 71 continues to move downward relative to the form 31. The pallet 33 is simultaneously moved downward at the same rate. Thus, the shoes 73 and 74 push the blocks 20a and 20b from the form while the blocks remain supported on the pallet 33, as shown in FIG. 11. The insert 40 remains with the blocks on the pallet 33 to protect the fragile faces on the blocks. If the block faces are designed with deep texture areas, it is likely that there will be damage to the fragile block faces is they are separated from the insert 40 before the concrete mix has had an opportunity to harden.

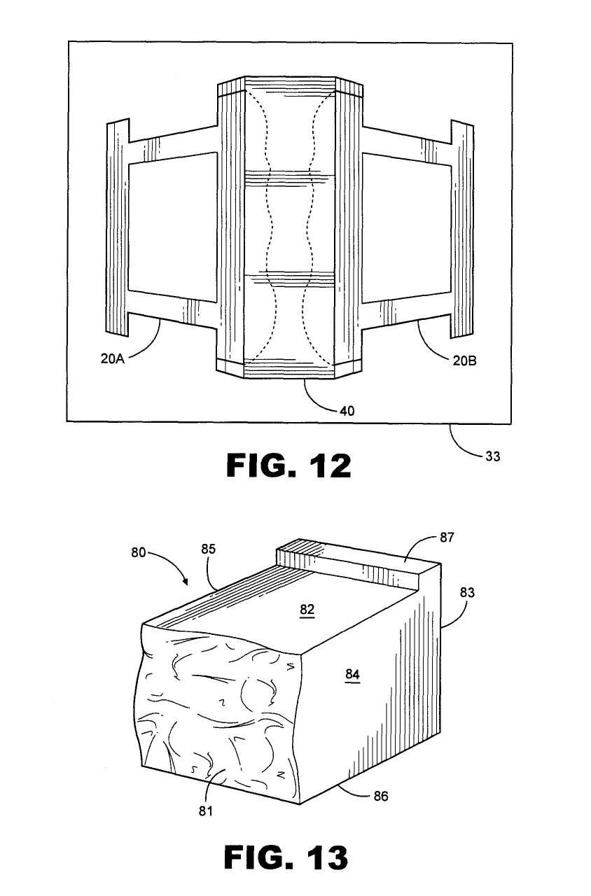

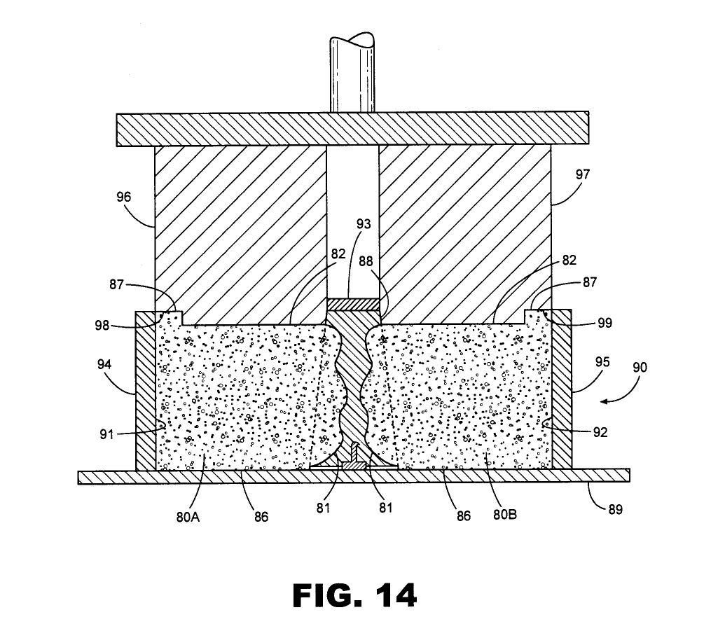

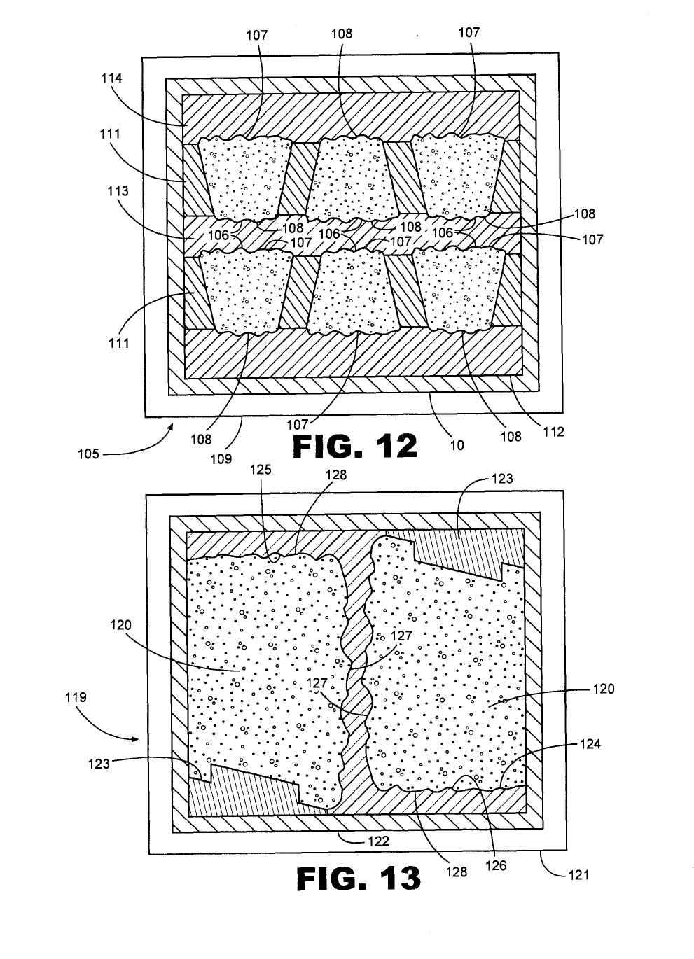

FIG. 12 shows the two blocks 20a and 20b on the pallet after the blocks and the insert 40 have been removed from the form 32. The two blocks 20a and 20b and the insert 40 are then transferred to a curing area. After the blocks are sufficiently hard, they are separated from the insert and the insert is used to cast additional blocks. The blocks 20a and 20b and the insert 40 may be transferred to the curing area on the pallet 33 and then may be pushed off of the pallet 33 onto another support surface so that the pallet can immediately be reused, or they may remain on the pallet while they cure. Alternately, the blocks and insert may be pushed from the pallet 33 onto another support surface for transfer to the cure area, such as onto a wood pallet (not shown).

FIG. 13 shows a dry cast concrete block 80 made according to a modified embodiment of the invention. The illustrated block 80 is a solid block without any central passages. If desired, the block 80 may include central passages. The block 80 has a textured face 81. The block 80 is manufactured and shown upside down, so that a bottom 82 of the block appears up. The block 80 has angled sides 83 and 84, a back 85 and a top 86. A lip 87 extends from the bottom 82 adjacent the back 83. In use, the block 80 is turned upright and stacked in rows to form a wall. Except for the lower most row of blocks, the lip 87 on each block is positioned behind an upper rear edge 88 of the block or blocks on which the block sits. Thus, the face 81 of each block 80 will be spaced slightly to the rear of the face 81 of the adjacent lower block. This provides a stable sloping wall in which the upper blocks cannot slide relative to the adjacent lower blocks. Blocks having this configuration are known in the concrete wall block field. However, the prior art did not allow blocks with a textured face and a rear lip to be manufactured using dry cast concrete block machines. A wet cast process was used for casting these blocks. An advantage of using a dry cast process is the higher production rate achieved with dry casting since the blocks do not have to remain in the form until after the concrete cures.

FIG. 14 illustrates a technique according to the invention for dry casting concrete blocks having a textured face 81 and a rear lip 87. An insert 88 is placed on the pallet 89 and the pallet 89 and insert 88 are mated with a form 90. In the illustrated embodiment, the insert 88, the pallet 89 and the form 90 define two cavities 91 and 92 for simultaneously casting two blocks 80a and 80b. However, the insert 88 may be modified for casting a single block 80 or for casting an even number of multiple blocks. The form 90 includes a plate 93 which is located above the insert 88. When the cavities 91 and 92 are filled with dry cast concrete mix and excess concrete mix is scraped from above the form 90, ridges or windrows of concrete are left on either side of the plate 93. This assures that there is sufficient concrete mix for casting the block faces. In addition, ridges or windrows of concrete mix may be left adjacent opposing sides 94 and 95 of the form 90 for forming the lip 87. Concrete mix forming a block 80a cast in the cavity 91 is compacted by a shoe 96 and concrete mix forming a block 80b cast in the cavity 92 is compacted by a shoe 97. The shoe 96 has a notch 98 for forming a lip 87 on the block 80a, and the shoe 97 has a notch 99 for forming a lip 87 on the block 80b.

In the illustrated block, the lip 87 extends the full width of the back of the block 80. It will be appreciated that the lip 87 may extend over a portion of the back of the block 80, or that two short lips 87 may be formed on the block, one adjacent each side. The shape, number and locations of the lips can be varied by varying the shape, number and locations of the notches 98 and 99.

FIG. 15 is a cross sectional plan view showing a mold 105 for simultaneously dry casting 6 concrete blocks 106 with each block 106 having two opposing textured faces 107 and 108. In order to facilitate arranging the blocks either in a straight line or along a curved line, the faces 107 are longer than the faces 108. The mold 105 consists of a pallet 109, a rigid form 110 which supports a plurality of cores 111 which separate adjacent blocks and three flexible inserts 112-114. The pallet 109, the form 110 and the cores 111 are all made from a rigid wear resistant material, such as steel and the flexible inserts 112-114 may be made, for example, primarily from a urethane. As with the prior embodiments, the inserts 112-114 may have a wear resistant surface which contacts the pallet 109 and may have one or more embedded magnets for resisting unintended movement of the inserts on the pallet. The inserts 112-114 and the form 110 also may be shaped so that the inserts will be pushed on the pallet to align with the form as the inserts are moved upwardly through the bottom of the form when the pallet, the inserts and the form are assembled to form the mold 105. The blocks 106 are illustrated as being solid. However, it should be appreciated that the blocks 106 may be cast with hollow centers similar to the blocks 20 by securing appropriate cores (not shown) to the form 110. After the mold 105 is filled with the dry cast concrete mix, excess mix is removed from above the form, and the concrete mix is compacted to form uncured blocks, the pallet 109 is lowered away from the form 110 and at the same time the uncured blocks 106 and the inserts 112-114 are pushed downwardly to separate from the form 110 and the cores, leaving the blocks 106 and the inserts 112-14 on the pallet. The blocks 106 and the inserts 112-114 are kept together while being transferred to a curing area and until the blocks 106 have sufficiently cured to permit separating from the inserts 112-114 without risk of the textured block faces 107-108. It should be appreciated that all of the simultaneously cast blocks may be the same, or that some or all of the blocks may have different textures on one or both of the faces 107 and 108.

FIG. 16 is a cross sectional plan view through a mold 119 for simultaneously casting two corner blocks 120 according to a further embodiment of the invention. The mold 119 includes a pallet 121, a form 122, optional cores 123 which are secured to the form 122 in the same manner that the cores are secured to the form in FIG. 3, and a flexible insert 124. The optional cores 123 shape one side of each block 120 similar to the shape of the sides of the block 120 in FIGS. 1 and 2. If the cores 123 are omitted, the blocks 120 will be more rectangular when viewed in plan. The illustrated insert 124 separates the form 122 into two cavities 125-126 in which the two blocks 120 are cast. The insert 124 is shaped to form textured faces 127 and 128 on two abutting sides of each block so that the blocks 120 can be used at wall corners. The interior of the form and the sides of the insert 124 may be angles to facilitate positioning of the insert in the form as the insert is raised into the interior of the form. If needed, magnets may be embedded in sides of the insert 124 for holding the insert sides against the walls of the form prior to filling the cavities with concrete mix. It will be appreciated that the insert 124 can be easily modified to form textured walls on three sides of the cast blocks. After the cavities 125 and 126 are filled with dry cast concrete mix and the mix is compacted to form the uncured blocks 120, the pallet 121, the blocks 120 and the insert 124 are separated from the form 122 and the cores 123, and the blocks 120 and the insert 124 are transferred together to a curing area. As with the previously described embodiments of the invention, the blocks 120 are not separated from the insert 124 until after the blocks 120 have sufficiently cured to prevent damage to the textured faces.

It will be appreciated that various modifications and changes may be made to the above-described preferred embodiments of the invention without departing from the scope of the following claims. The illustrated embodiments of the invention show a mold for simultaneously casting two blocks with decorative faces. It should be understood that the mold may be modified for casting only a single block or for simultaneously casting an even number of blocks.

1. A method for dry casting at least one concrete block having a textured face comprising the steps of:
a) providing a mold including a rigid pallet, a form having an open bottom and at least one flexible insert, the flexible insert having a shaped surface for imparting texture to the face of a cast block;
b) positioning the insert on the pallet with the shaped surface extending above the pallet;
c) positioning the pallet and the form wherein the pallet closes the bottom of the form and the insert extends upwardly into said form to define at least one mold cavity with the insert forming one side of the cavity;
d) filling the cavity with dry mix concrete;
e) removing any excess dry mix concrete from above the mold cavity;
f) compacting the dry mix concrete in the mold cavity to form an uncured block;
g) transferring the uncured block and the flexible insert together to a curing area; and
h) separating the block from the flexible insert after the block has cured.

2. A method for dry casting concrete blocks having a textured face, as set forth in claim 1, and wherein the provided pallet is a steel pallet, wherein the provided insert has at least one magnet embedded in a lower area of the insert; and wherein when the insert is positioned on the pallet, the embedded magnet attracts the insert to the pallet for stabilizing the insert on the pallet when the pallet and the form are positioned with the pallet closing the bottom of the form, while allowing the insert to slide on the pallet for alignment with the form.

3. A method for dry casting concrete blocks having a textured face, as set forth in claim 1, and wherein the form has two opposing walls with each of the opposing walls having an angled surface area which aligns and holds the position of the insert relative to the form when the pallet and insert are positioned where the pallet closes the bottom of the form.

4. A method for dry casting concrete blocks having a textured face, as set forth in claim 1, and further including the step of providing a wear resistant surface on a bottom of the flexible insert.

5. A method for dry casting concrete blocks having a textured face, as set forth in claim 1, and wherein the flexible insert is provided with two textured faces on opposite sides of the flexible insert; and wherein when the pallet and the form are positioned with the pallet closing the bottom of the form, the flexible insert is positioned to divide the mold into separate cavities on opposite sides of the flexible insert for simultaneously casting two blocks, wherein both cavities are filled with dry mix concrete, excess dry mix concrete is removed from above both cavities, the dry mix concrete is simultaneously compressed in both cavities to form two uncured blocks, wherein the two uncured blocks and the insert are moved together to a curing area, and wherein the two blocks are separated from the flexible insert after both blocks have cured.

6. A method for dry casting concrete blocks having a textured face, as set forth in claim 5, and wherein when the mold cavities are filled with dry mix concrete, a windrow of dry mix concrete is left above each mold cavity adjacent the flexible insert when excess dry mix concrete is removed from above the mold cavity, and wherein the windrows are sized to assure that there is sufficient dry mix concrete to form a complete textured face on each block.

7. A method for dry casting concrete blocks having a textured face, as set forth in claim 6, and including the step of providing a doctor for scraping excess dry mix concrete from above the form, and wherein the doctor is provided with at least one notch for forming the windrows.

8. A method for dry casting concrete blocks having a textured face, as set forth in claim 6, wherein the form has a wall spaced from the insert which forms a back of the cast block, and wherein the dry mix concrete is compressed by moving a shoe into the mold to compress the dry mix concrete, and wherein the shoe has at least one notch adjacent the form wall for forming at least one rib extending from a surface of the block adjacent the back of the cast block.

9. A method for dry casting concrete blocks having a textured face, as set forth in claim 1, and wherein the textured insert forms at least two abutting faces on each cast block.

10. A method for dry casting concrete blocks having a textured face, as set forth in claim 1, and wherein when the mold cavities are filled with dry mix concrete, a windrow of dry mix concrete is left above each mold cavity adjacent the flexible insert when excess dry mix concrete is removed from above the mold cavity, and wherein the windrows are sized to assure that there is sufficient dry mix concrete to form a complete textured face on each block.

11. A method for dry casting concrete blocks having a textured face, as set forth in claim 10, and including the step of providing a doctor for scraping excess dry mix concrete from above the form, and wherein the doctor is provided with at least one notch for forming the windrow.

12. A method for dry casting concrete blocks having a textured face, as set forth in claim 1, wherein the form has a wall spaced from the insert which forms a back of the cast block, and wherein the dry mix concrete is compressed by moving a shoe into the mold to compress the dry mix concrete, and wherein the shoe has at least one notch adjacent the form wall for forming at least one rib extending from a surface of the block adjacent the back of the cast block.

13. A method for dry casting concrete blocks having a textured face, as set forth in claim 1, and wherein the textured insert forms at least two abutting faces on the cast block.

14. A method for dry casting concrete blocks having a textured face, as set forth in claim 1, and wherein at least two flexible inserts are positioned on the pallet with each insert having a shaped surface for imparting texture to two opposing faces of a cast block, wherein the two flexible inserts are positioned on the pallet prior to positioning the pallet and the form wherein the pallet closes the bottom of the form with the inserts extending upwardly into the form to create at least one mold cavity with a shaped surface of two inserts forming opposing sides of the cavity, wherein the at least one cast block and the inserts are transferred together to a curing area, and wherein the at least one block is separated from the inserts after the block has cured.

15. A mold for casting at least one block from dry mix concrete, said block having a textured face, said mold comprising a rectangular form having an open top and an open bottom, a pallet closing said form bottom to define a mold cavity, a flexible insert having a bottom supported on the cavity to extend upwardly into said form between two opposing walls of said form, said insert supported on the pallet and having at least one wall shaped to impart a desired texture to a face on a block cast in said cavity, wherein the two opposing walls of the form include means for releasably positioning the insert within the form whereby when the form and the pallet are separated the insert and a block cast in the cavity remain on the pallet.

16. A mold for casting at least one block from dry mix concrete, as set forth in claim 16, wherein a side wall of said form opposite the shaped insert wall forms a back of a block cast in said cavity and further including means for compressing dry mix concrete in said mold cavity to form an uncured block having a projecting rib adjacent said back of a block cast in said cavity.

17. A mold for casting at least one block from dry mix concrete, as set forth in claim 15, and wherein said pallet is a steel pallet, and wherein said insert has at least one embedded magnet adjacent said insert bottom for stabilizing said insert on said pallet while permitting said insert to slide relative to said pallet.

18. A mold for casting at least one block from dry mix concrete, as set forth in claim 15, and wherein said bottom of said insert includes a wear resistant surface.
